(19) United States
(12) Patent Application Publication
(10) Pub. No.: US 2014/0110397 A1
(43) Pub. Date: Apr. 24, 2014

(54) Flexible Electrical Heating Element and Manufacturing Method Thereof

(71) Applicant: FENG CHIA UNIVERSITY, Taichung City (TW)

(72) Inventors: Ju-Liang He, Taichung City (TW); Chiao-Chih Hsu, Taichung City (TW); Jen-Tsung Wang, Taichung City (TW); Chun-Ming Chen, Taichung City (TW)

(73) Assignee: Feng Chia University, Taichung City (TW)

(21) Appl. No.: 13/868,572

(22) Filed: Apr. 23, 2013

(30) Foreign Application Priority Data
Oct. 19, 2012 (TW) 101138689

(51) Int. Cl. H05B 3/34

(52) U.S. Cl. CPC H05B 3/342
USPC 219/529; 219/528; 427/122; 427/576

(57) ABSTRACT

This invention proposes a flexible electrical heating element comprising a substrate, a metal interlayer coating and a far-infrared emissive carbon film. The flexible electrical heating element utilizes a low-cost and environmental friendly vacuum coating technique to deposit the metal interlayer coating and the far-infrared emissive carbon film on the flexible and insulating substrate which can provide uniform heating, and the far-infrared emissive carbon film can emit far-infrared.

### BACKGROUND OF THE INVENTION

1. Field of the Invention

This present invention relates to a flexible electrical heating element, more particularly to a flexible electrical heating element and manufacturing method thereof.

2. Description of the Prior Arts

Conventional electrical heating products are usually built by stiff, fragile and inflexible heating element such as metal wires, carbon heater and ceramic radiator. They bring inconvenience and are dangerous to the user caused by non-uniformly localized heating, user un-friendliness and the ease for electrical breakdown when in the situation of inappropriate bending during service. The heating element made from conventional carbon fiber though get rid of the problems stated above, the carbonization process for manufacturing carbon fiber is environmental unfriendly and expensive.

### SUMMARY OF THE INVENTION

In order to improve drawbacks stated in the Prior Arts, this invention proposes a flexible electrical heating element comprising a substrate as an insulating material which could be a polymeric fiber fabric or a glass fiber fabric, a metal interlayer coating deposited on the fabric substrate, and a carbon film deposited as the out most layer with far-infrared emission capability, wherein the flexible electrical heating element utilizing a vacuum coating technique to successively deposit the metal interlayer coating and the far-infrared emissive carbon film. Moreover, this invention proposes a method of manufacturing a flexible electrical heating element utilizing the vacuum coating technique comprising the following steps:

a. substrate cleaning,

b. depositing the metal interlayer coating onto the substrate,

c. depositing the far-infrared emissive carbon film by using hydrocarbon gas onto the metal interlayer coating,

d. the flexible electrical heating element manufactured.

An advantage of this invention is utilizing the vacuum coating clean process to evenly deposit the metal interlayer coating and the far-infrared emissive carbon film onto a flexible insulating material, particularly in form of fabric. The uniformly covered metal interlayer coating provides area heating and carbon film emits far-infrared. The flexible insulating substrate performs as the support to further prevent fracture, damage or unexpected disaster for inappropriate bending during service. In addition, the flexible electrical heating element is capable of revitalizing human tissues beneficial from the far-infrared emitted by the carbon film. Moreover, based on the demands, an antibiotic, electromagnetic shielding or any other functions can be built in by depositing additional functional coatings onto the carbon film by utilizing the vacuum coating technique successively. By utilizing the vacuum coating technique, it reduces manufacturing cost and avoids the complexity brought by the conventional manufacturing process to increase additional functions of the flexible electrical heating element.

### BRIEF DESCRIPTION OF THE DRAWINGS

FIG. 1 illustrates a flexible electrical heating element of the invention.

FIG. 2 illustrates the steps of manufacturing method of this invention.

FIG. 3 illustrates the heating effectiveness of the invented flexible heating element.

FIG. 4 illustrates the far-infrared emissivity of the invented flexible heating element.

### DETAILED DESCRIPTION OF THE INVENTION

Hereinafter, embodiments of this invention will be explained in detail with reference to the drawings; however, this invention is not limited thereto.

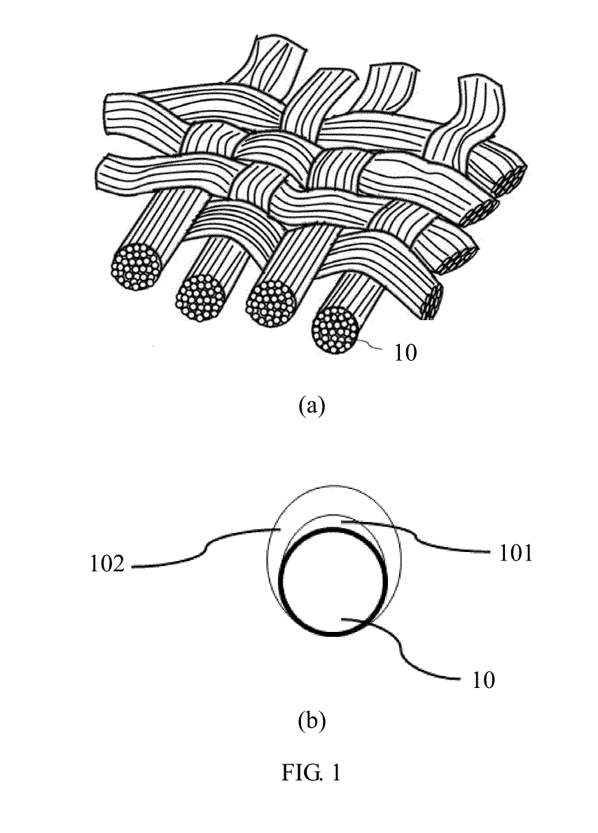

FIG. 1 illustrates a flexible electrical heating element 1 of this invention comprising a substrate 10 as an insulating material, a metal interlayer coating 101 deposited on the fabric substrate 10, and a far-infrared emissive carbon film 102 deposited as the out most layer with far-infrared emission capability, wherein the flexible electrical heating element 1 utilizing a vacuum coating technique to successively deposit the metal interlayer coating 101 and the far-infrared emissive carbon film 102. The substrate 10 is an insulating material which can be a flexible board, a fiber bundles, a fiber fabric or a non-woven fabric; the preferred choice can be a polymeric fiber fabric or a glass fiber fabric. The metal interlayer coating 101 is heated when external voltage is applied and the metal interlayer coating 101 comprises refractory metals suitable to the vacuum coating technique, such as niobium (Nb), molybdenum (Mo), tantalum (Ta), tungsten (W), rhenium (Re), titanium (Ti), vanadium (V), chromium (Cr), zirconium (Zr), hafnium (Hf), ruthenium (Ru), osmium (Os) or iridium (Ir) and an alloy therefrom, wherein tungsten (W), titanium (Ti) or the chromium (Cr) is preferred. The far-infrared emissive carbon film 102 is obtained onto the metal interlayer coating 101 by utilizing the vacuum coating technique, whilst employing hydrocarbon gas as the raw material to form the far-infrared emissive carbon film 102 on the flexible electrical heating element 1 with far-infrared emission capability. The hydrocarbon gas comprises acetylene (C₂H₂), methane (CH₄) or ethane (C₂H₆), wherein the acetylene (C₂H₂) is preferred. Moreover, based on the demands, an antibiotic, electromagnetic shielding or any other functions can be built in by depositing additional functional coatings onto the far-infrared emissive carbon film 102 by utilizing the vacuum coating technique successively. The vacuum coating technique comprises the physical vapor deposition (PVD) technique or the chemical vapor deposition (CVD) technique, wherein the cathodic arc plasma system (CAPD) technique of the PVD families is preferred.

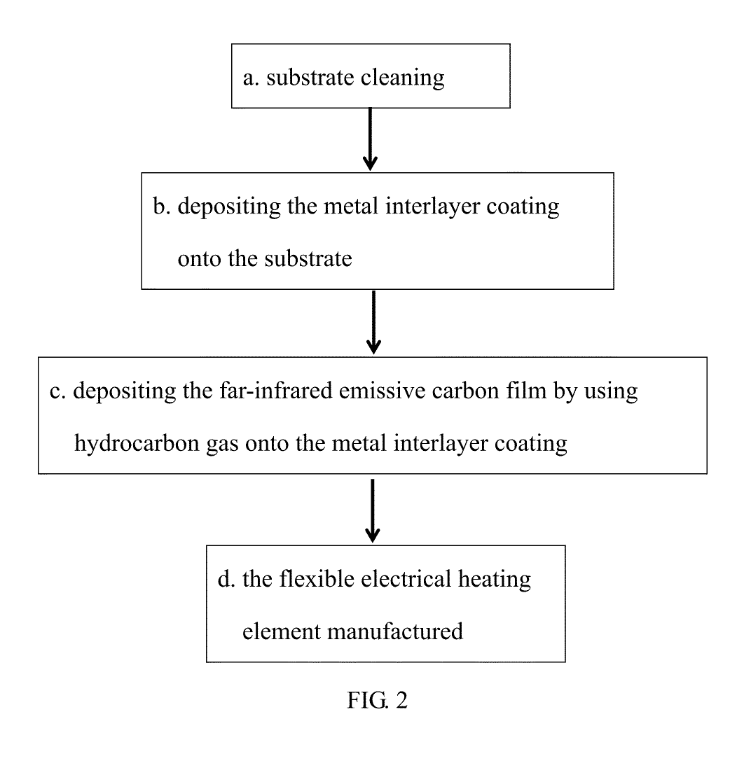

Refer to FIG. 2 and TABLE 1. TABLE 1 provides parameters for each state of coating process. FIG. 2 illustrates the steps of manufacturing method of this invention comprising the substrate 10, the metal interlayer coating 101, and the far-infrared emissive carbon film 102 according to the parameters listed in the TABLE 1, the steps comprise as follows:

a. substrate 10 cleaning,

the substrate 10 which can be the insulating material comprising the flexible board, the fiber bundles, the fiber fabric or the non-woven fabric, the preferred choice can be a polymeric fiber fabric or a glass fiber fabric,

b. depositing the metal interlayer coating 101 onto the substrate 10,

the refractory metals used in the metal interlayer coating 101 deposition comprising niobium (Nb), molybdenum (Mo), tantalum (Ta), tungsten (W), rhenium (Re), titanium (Ti), vanadium (V), chromium (Cr), zirconium (Zr), hafnium (Hf), ruthenium (Ru), osmium (Os) or iridium (Ir),

c. depositing the far-infrared emissive carbon film 102 by using hydrocarbon gas onto the metal interlayer coating 101,

the hydrocarbon gas comprising acetylene (C₂H₂), methane (CH₄) or ethane (C₂H₆) and the preferred choice which can be acetylene (C₂H₂),

d. the flexible electrical heating element 1 manufactured.

TABLE 1

| Parameters | | Value |
|---|---|---|
| Ion bombardment | Argon (Ar) flow rate (sccm) | 50~100 |
| | Working pressure (Pa) | 0.5~1 |
| | Bombardment time (min) | 4~8 |
| | Substrate bias (−V) | 200~250 |
| Coating process for the | Target material | Metal |
| metal interlayer coating | Ar flow rate (sccm) | 50~100 |
| 101 | Working pressure (Pa) | 0.5~1 |
| | Deposition time (min) | 4~8 |
| | Target current (A) | 60~100 |
| Coating process for the | Target material | Metal |
| far-infrared emissive | C₂H₂ flow rate (sccm) | 50~200 |
| carbon film 102 | Working pressure (Pa) | 0.04~0.26 |
| | Deposition time (min) | 20~60 |
| | Target current (A) | 100~150 |

In step a., the substrate 10 is put into the CAPD to be cleaned by removing the surface contaminant for improving coating adhesion in accordance with the parameters of ion bombardment in the TABLE 1. In step b., the metal interlayer coating 101 is deposited by the refractory metals as a target on the substrate 10, and tungsten (W), titanium (Ti) or chromium (Cr) as preferred refractory metals. In step c., the far-infrared emissive carbon film 102 by applying the hydrocarbon gas; afterwards, the flexible electrical heating element 1 is manufactured.

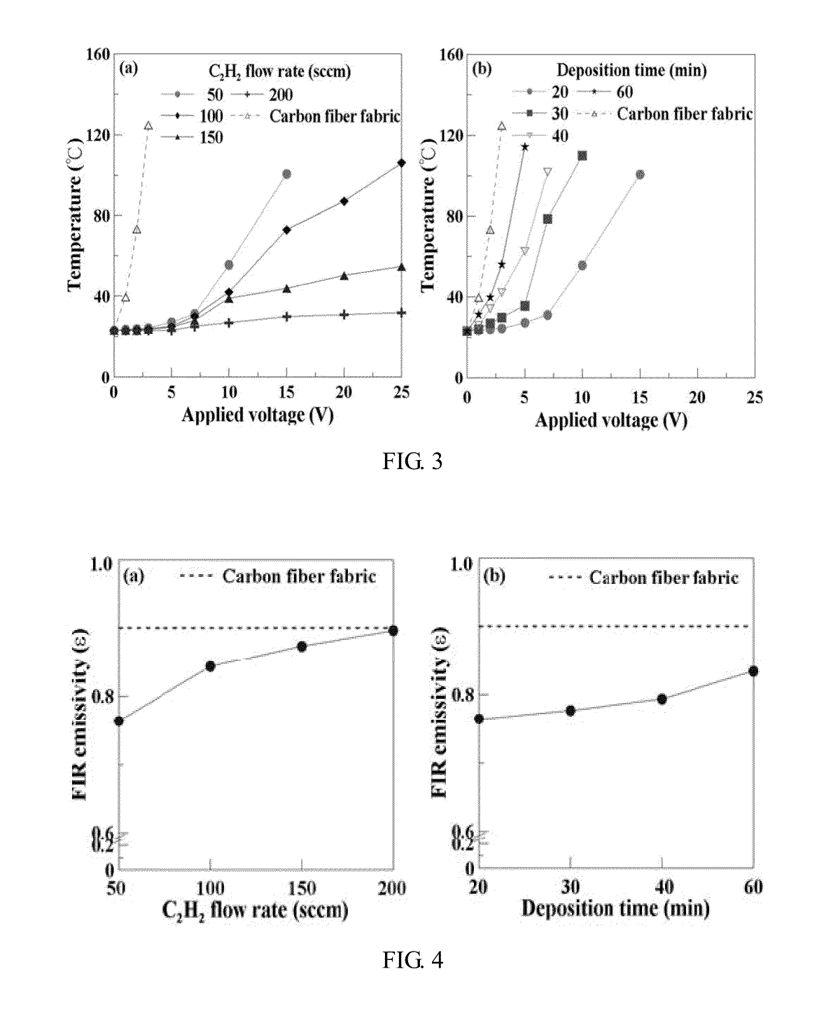

FIG. 3 illustrates the heating effectiveness of the invented flexible heating element 1, which is manufactured by cathodic arc plasma technique by adjusting the hydrocarbon gas flow rate and deposition time of the far-infrared emissive carbon film 102, respectively. FIG. 3(a) indicates that the less the C₂H₂ flow rate is, the faster temperature rise of the flexible electrical heating element 1 is, wherein the C₂H₂ flow rate preferably sets between 50 standard cubic centimeters per minute (sccm) to 200 sccm. Under a circumstance of constant voltage of 15 volt, when the C₂H₂ flow rate respectively sets at 50 sccm and 150 sccm, temperature respectively rises to 100 Celsius degrees (° C.) and 40° C. FIG. 3(b) indicates that under a circumstance of constant C₂H₂ flow rate, the longer the deposition time is, the faster the temperature rise of the flexible electrical heating element 1 is, wherein the deposition time preferably sets between 20 minutes (min) to 60 min. Under a circumstance of constant voltage of 10 volt, when the deposition time respectively sets at 20 min and 30 min, the temperature respectively rises to over 50° C. and over 100° C. FIG. 4 illustrates the far-infrared (FIR) emissivity of the invented flexible electrical heating element 1, which is manufactured by cathodic arc plasma technique by adjusting the hydrocarbon gas flow rate and the deposition time of the far-infrared emissive carbon film 102, respectively. FIG. 4(a) indicates that far-infrared (FIR) emissivity increases as the C₂H₂ flow rate increases. When the C₂H₂ flow rate is 200 sccm, the far-infrared (FIR) emissivity reaches approximately 90%. FIG. 4(b) indicates that the far-infrared (FIR) emissivity increases as the deposition time increases. When the deposition time increases from 30 min to 60 min, the far-infrared (FIR) emissivity increases over 80%.

Adjustment of the coating parameters for the hydrocarbon gas can affect the heating efficiency (in terms of temperature rise) and the far-infrared emissivity. Hence, based on demands, this invention can adjust coating parameters to manufacture the flexible electrical heating element 1 in a low-cost method.

This and other modification, as will occur to those skilled in the art, may be made in the exemplary embodiments shown without departing from the spirit of the invention and the exclusive use of all modification as come within the scope of the appended claims is contemplated.

What is claimed is:

1. A flexible electrical heating element comprises:
a substrate as an insulating material;
a metal interlayer coating depositing on the substrate; and
a far-infrared emissive carbon film deposited as an outer most layer;
the flexible electrical heating element utilizing a vacuum coating technique to deposit the metal interlayer coating and the far-infrared emissive carbon film on the substrate.

2. The flexible electrical heating element as claimed in claim 1, wherein the insulating material is a flexible board, a fiber bundles, a fiber fabric or a non-woven fabric.

3. The flexible electrical heating element as claimed in claim 2, wherein the insulating material is preferred for a polymeric fiber fabric or a glass fiber fabric.

4. The flexible electrical heating element as claimed in claim 1, wherein the metal interlayer coating comprises refractory metals and an alloy of the refractory metals.

5. The flexible electrical heating element as claimed in claim 4, wherein the refractory metals comprise niobium (Nb), molybdenum (Mo), tantalum (Ta), tungsten (W), rhenium (Re), titanium (Ti), vanadium (V), chromium (Cr), zirconium (Zr), hafnium (Hf), ruthenium (Ru), osmium (Os) or iridium (Ir).

6. The flexible electrical heating element as claimed in claim 5, wherein the metal interlayer coating is preferred for tungsten (W), titanium (Ti) or chromium (Cr).

7. The flexible electrical heating element as claimed in claim 1, wherein the far-infrared emissive carbon film is obtained onto the metal interlayer coating by employing hydrocarbon gas as the raw material.

8. The flexible electrical heating element as claimed in claim 7, wherein the hydrocarbon gas comprises acetylene (C₂H₂), methane (CH₄) or ethane (C₂H₆).

9. The flexible electrical heating element as claimed in claim 8, wherein the hydrocarbon gas is preferred for acetylene (C₂H₂).

10. The flexible electrical heating element as claimed in claim 1, wherein the vacuum coating technique is physical vapor deposition (PVD) or chemical vapor deposition (CVD).

11. The flexible electrical heating element as claimed in claim 10, wherein the vacuum coating technique is preferred for cathodic arc plasma system (CAPD).

12. The flexible electrical heating element as claimed in claim 1, wherein an antibiotic, electromagnetic shielding or any other functions is built by depositing additional functional coatings onto the far-infrared emissive carbon film by utilizing the vacuum coating technique.

13. A method of manufacturing a flexible electrical heating element utilizing the vacuum coating technique comprising a substrate, a metal interlayer coating, and a far-infrared emissive carbon film comprises following steps:
a. substrate cleaning;
b. depositing the metal interlayer coating onto the substrate;
c. depositing the far-infrared emissive carbon film by using hydrocarbon gas onto the metal interlayer coating;
d. the flexible electrical heating element manufactured.

14. The method of manufacturing the flexible electrical heating element as claimed in claim 13, wherein the substrate in the step a. is an insulating material comprising a flexible board, a fiber bundles, a fiber fabric or a non-woven fabric.

15. The method of manufacturing the flexible electrically heated element as claimed in claim 14, wherein the insulating material is preferred for a polymeric fiber fabric or a glass fiber fabric.

16. The method of manufacturing the flexible electrical heating element as claimed in claim 13, wherein the metal interlayer coating in the step b. comprises refractory metals and an alloy of the refractory metals.

17. The method of manufacturing the flexible electrical heating element as claimed in claim 16, wherein the refractory metals comprise niobium (Nb), molybdenum (Mo), tantalum (Ta), tungsten (W), rhenium (Re), titanium (Ti), vanadium (V), chromium (Cr), zirconium (Zr), hafnium (Hf), ruthenium (Ru), osmium (Os) or iridium (Ir).

18. The method of manufacturing the flexible electrical heating element as claimed in claim 17, wherein the metal interlayer coating is preferred for tungsten (W), titanium (Ti) or chromium (Cr).

19. The method of manufacturing the flexible electrical heating element as claimed in claim 13, wherein the hydrocarbon gas in the step c. comprises acetylene (C₂H₂), methane (CH₄) or ethane (C₂H₆).

20. The method of manufacturing the flexible electrical heating element as claimed in claim 19, wherein the hydrocarbon gas is preferred for acetylene (C₂H₂).

21. The method of manufacturing the flexible electrical heating element as claimed in claim 13, wherein a parameter of a flow rate and a parameter of a deposition time of the hydrocarbon gas influence coating properties.

22. The method of manufacturing the flexible electrical heating element as claimed in claim 21, wherein the flow rate preferably sets between 50 standard cubic centimeters per minute (sccm) to 200 sccm.

23. The method of manufacturing the flexible electrical heating element as claimed in claim 21, wherein the deposition time preferably sets between 20 minutes (min) to 60 min.

24. The method of manufacturing the flexible electrical heating element as claimed in claim 13, wherein the vacuum coating technique is physical vapor deposition (PVD) or chemical vapor deposition (CVD).

25. The method of manufacturing the flexible electrical heating element as claimed in claim 24, wherein the vacuum coating technique is preferred for cathodic arc plasma system (CAPD).
